(19) United States
(12) Patent Application Publication
(10) Pub. No.: US 2018/0098041 A1
(43) Pub. Date: Apr. 5, 2018

(54) ADAPTIVE CHROMA SUBSAMPLING BASED ON DISPLAY BRIGHTNESS

(71) Applicant: Sean J. Lawrence, Bangalore (IN)

(72) Inventor: Sean J. Lawrence, Bangalore (IN)

(21) Appl. No.: 15/282,639

(22) Filed: Sep. 30, 2016

(51) Int. Cl. H04N 9/68; H04N 21/4363; H04N 21/2385

(52) U.S. Cl. CPC H04N 9/68; H04N 21/2385; H04N 21/43637

(57) ABSTRACT

An apparatus is described herein. The apparatus includes comprising a brightness capture mechanism and a controller. The brightness capture mechanism is to obtain ambient brightness and display brightness. The controller is to determine a chroma subsampling scheme of a video based on the ambient brightness and display brightness according to a human visual system response, wherein the controller is to adapt a chroma subsampling ratio based on the ambient brightness and display brightness.

### BACKGROUND ART

Electronic devices can render videos and images on a display device. The display device may be housed within the electronic device, or the display device can be remote from the electronic device. The rendered content may affect brightness near the display device. The brightness from the display device can have an impact on the way color is perceived by the human eye.

### BRIEF DESCRIPTION OF THE DRAWINGS

FIG. 1 is a block diagram of an exemplary system that enables chroma subsampling based on display brightness;

FIG. 2 is a graph illustrating vision types as compared to human photoreceptor cells;

FIG. 3 is a block diagram of a wireless display transmitter;

FIG. 4 is an illustration of determining a chroma subsampling scheme;

FIG. 5 is an illustration of the human visual response to darkness;

FIG. 6 is a process flow diagram of a method for remote adaptation of streaming data based on the luminance at a receiver; and

FIG. 7 is a block diagram showing media that contains logic for adapting chroma subsampling based on display brightness.

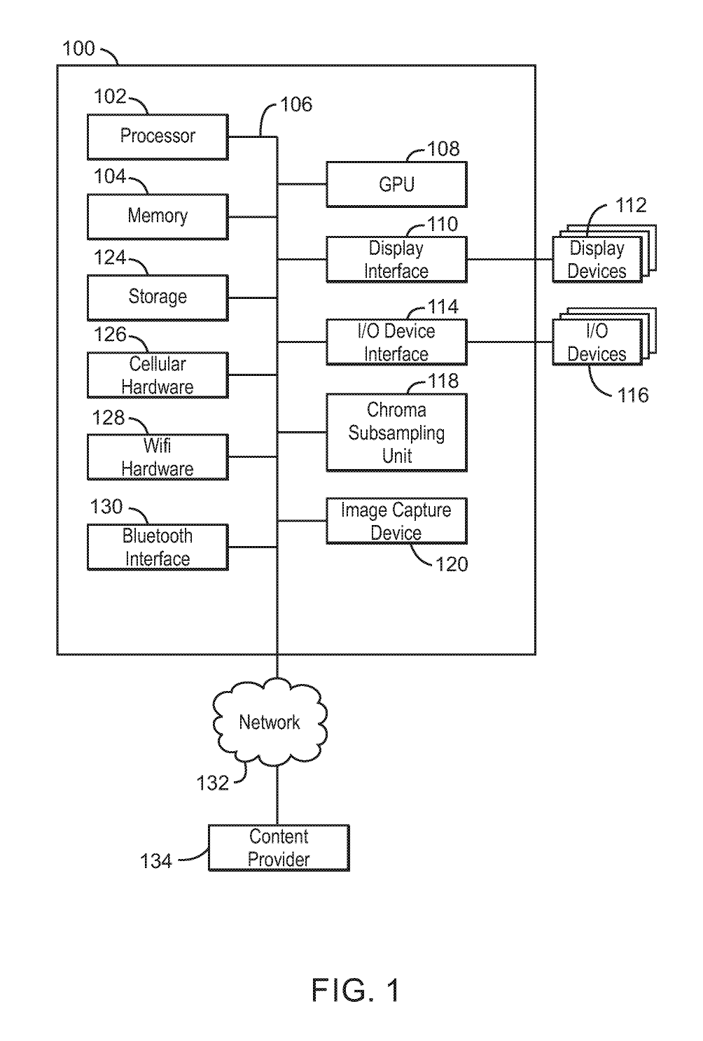

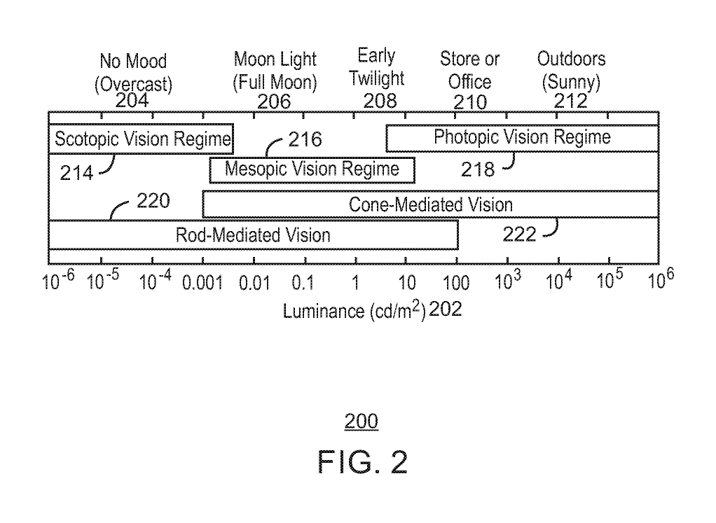

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

A display device may be used to render media content for viewing such as watching a movie or video. The media content may be viewed under various levels of ambient and display brightness. As used herein, ambient brightness refers to lighting in a space that results from light sources in the space, other than and excluding the display device. Display brightness refers to the brightness of a space that directly results from a particular display device. While color information is necessary during all brightness scenarios, the amount of necessary color information sent to and rendered on the display may vary. This is due to the inherent nature of scotopic, mesopic and photopic vision of the human visual system. In other words, the color information that is necessary in each brightness scenario may be modified or reduced based on the color perception capabilities of an average human being. In systems that send full color information these low brightness scenarios can result in unnecessary color information being sent to the display. For example, full color information may be sent when a 4:4:4 chroma subsampling is performed in a low lighting scenario, where less color information may be used to adequately render the media content. As a result, there exists an opportunity for bandwidth saving in high chroma sampled (4:4:4) systems during low screen brightness and low ambient light scenarios.

Embodiments described herein enable adaptive chroma subsampling based on display brightness. In embodiments, the present techniques adaptively vary the amount of necessary color information sent to and rendered on the display in response to various levels of ambient brightness and display brightness. In embodiments, the color information is obtained from various media content that is presented to a user by being rendered on the display. Media content may include, but is not limited to content such as images, text, video, audio, and animations. In some cases, the media content may be rendered using a wireless display technique. Wireless display (WiDi) is a technique by which a desktop of an electronic device is rendered on a remote display, wirelessly. For example, a tablet device may send all images on its local display to a television to be rendered. Typical uses for WiDi may include online video playback over a web browser and video chat. Each of these uses involve encoding the media content at a receiver and then wirelessly transmitting the media content to a remote display. In any event, the use of WiDi may consume a relatively large amount of power, as the images from the display to be rendered are typically encoded, decoded, and processed. The present techniques enable a reduction in the amount of information encoded, decoded, and processed while rendering the media content in a manner that is indistinguishable by the human eye from the original, full, unsampled media content.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an exemplary system that enables chroma subsampling based on display brightness. In embodiments, the chroma subsampling is adaptive such that the subsampling ratios mimic or correspond to the expected performance of the human visual system. Thus, the sampling ratios can be changed on the fly, in real time, in response to display brightness. The electronic device 100 may be, for example, a laptop computer, tablet computer, mobile phone, smart phone, or a wearable device, among others. The electronic device 100 may be used to receive and render media such as images and videos. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, streaming data, or the like, to be rendered or displayed to a user of the electronic device 100. In some embodiments, the GPU 108 includes a number of graphics engines, wherein each graphics engine is configured to perform specific graphics tasks, or to execute specific types of workloads.

The CPU 102 can be linked through the bus 106 to a display interface 110 configured to connect the electronic device 100 to one or more display devices 112. The display devices 112 can include a display screen that is a built-in component of the electronic device 100. In embodiments, the display interface 110 is coupled with the display devices 112 via any networking technology such as cellular hardware 124, Wifi hardware 126, or Bluetooth Interface 128 across the network 132. The display devices 112 can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116. The I/O devices 116 can include, for example, a keyboard and a pointing device, wherein the pointing device can include a touchpad or a touchscreen, among others. The I/O devices 116 can be built-in components of the electronic device 100, or can be devices that are externally connected to the electronic device 100. Accordingly, in embodiments, the I/O device interface 114 is coupled with the I/O devices 116 via any networking technology such as cellular hardware 124, Wifi hardware 126, or Bluetooth Interface 128 across the network 132. The I/O devices 116 can also include any I/O device that is externally connected to the electronic device 100.

The electronic device 100 also includes an adaptive chroma subsampling unit 118. The adaptive chroma subsampling unit 118 is to vary the chroma subsampling according to ambient brightness and/or display brightness. The adaptive chroma subsampling unit 118 may include, for example, a plurality of sensors that are used to obtain ambient brightness. The sensors may include, but are not limited to, an ambient light sensor (ALS), a temperature sensor, a humidity sensor, a motion sensor, and the like. The electronic device also includes an image capture device 120. The image capture device 120 may be a camera or plurality of sensors used to capture images. In embodiments, the image capture device 120 is a component of the adaptive chroma subsampling unit 118.

In chroma subsampling, image data may be sampled by obtaining data points with less resolution for the chroma information than for luma information. This subsampling may be performed in a YUV color space, where the Y component determines the brightness of the color, referred to as luminance or luma information. The U and V components are color difference components used to determine the color itself, which is the chroma information. In embodiments, the chroma subsampling is a expressed as a three part ratio, where the parts include a horizontal sampling reference, number of chrominance samples in a row of pixels, and a number of changes of chrominance samples between a first and second row of pixels.

In addition to sensors of the adaptive chroma subsampling unit 118, the image capture device 120 may be used to obtain ambient brightness and/or display brightness. The image capture device may be a camera or an image sensor. Images captured by the image capture device 120 can be analyzed to determine ambient brightness, such as lighting and color temperatures of the surrounding space.

The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, GPU 108, or any other processors that may be included in the electronic device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union-Radio communication Sector (ITU-R)). In this manner, the electronic device 100 may access any network 132 without being tethered or paired to another device, where the cellular hardware 126 enables access to the network 132.

The CPU 102 may also be linked through the bus 106 to WiFi hardware 128. The WiFi hardware 128 is hardware according to WiFi standards (standards promulgated as Institute of Electrical and Electronics Engineers' (IEEE) 802.11 standards). The WiFi hardware 128 enables the electronic device 100 to connect to the Internet using the Transmission Control Protocol and the Internet Protocol (TCP/IP). Accordingly, the electronic device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the electronic device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others.

The network 132 may be used to obtain streaming data from a content provider 134. In embodiments, the media content to be rendered may be obtained in a wired or wireless fashion. The content provider 134 may be any source that provides streaming data to the electronic device 100. The content provider 134 may be cloud based, and may include a server. In embodiments, the content provider 134 may be a gaming device. Users of a mobile device, such as the electronic device 100, stream content to their respective mobile device that originates at the content provider 134. Frequently, users watch streaming data in environments where lighting often changes. The present techniques can adjust the color information of the content to be rendered based on changes in lighting.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

The present techniques enable any content to be rendered by adaptively varying the types of sampling and subsampling based on the surrounding conditions, such as ambient lighting and/or the display brightness. The rendered content appears appropriately to the eyes of an end-user, while the sampling and subsampling is optimized to ensure that a minimum amount of bandwidth is used within the system to render the video appropriately for a user. Without this chromatic compensation, the rendered content may unnecessarily consume a large amount of bandwidth and processing time by rendering a higher quality of content than is necessary based on the present conditions. As a result, extra power and valuable clock cycles may be wasted when rendering content without adaptive chroma subsampling.

The present techniques reduce the chroma sampling ratio to lower chroma subsampling ratios during scenarios of low display brightness and/or low ambient light by taking advantage of the fact of the inherent mesopic nature of vision at these levels of brightness. In embodiments, the type of chroma subsampling is directly tied to the human visual system. The chroma subsampling may mimic the expected range of vision of a human based on the display brightness and/or ambient lighting. Accordingly, the chroma subsampling may be based on the scotopic, mesopic and photopic vision of the human visual system.

Scotopic vision may be the vision of the eye under low light conditions, while photopic vision may be the vision of the eye under well-lit conditions. Mesopic vision may be a combination of photopic vision and scotopic vision in low but not quite dark lighting situations. Mesopic light levels range from luminances of approximately 0.001 to 3 cd m⁻². In embodiments, the chroma sampling or subsampling may vary according to the known vision limits of the human eye based on the ambient conditions and the display brightness. Thus, the chroma sampling or subsampling is varies in a manner similar to the variations in vision as perceived by the human eye. The human visual system is highly optimized to see differently at different lighting levels through the use of eye cones or rods. Moreover, during any of scotopic, mesopic, or photopic vision, the human eye may be more sensitive to particular colors. For example, during photopic vision humans may be sensitive to light that is greenish-yellow. In scotopic vision, humans may be more sensitive to greenish blue light. Accordingly, in embodiments, the color information may be adapted to reduce the colors that the human eye may be most sensitive to based on the ambient lighting and display brightness.

Bright line luminescence values to separate photopic vision and scotopic vision may not exist. Instead, mesopic vision is used to describe a band of transition between photopic vision and scotopic vision. Thus, the cones and rods of the human eye are not switched on and/or off, where cones and rods are photosensitive cells of the human eye that enable vision based on lighting conditions. Rather, the human visual system uses cones and rods in an adaptive fashion based on the lighting conditions. Adaptive chroma subsampling can be performed in a manner that is to compliment the human visual system. In some embodiments, ambient brightness and display brightness can be used to vary the color information and brightness based on the expected reaction of the human visual system. For ease of description, the present techniques are described as varying the adaptive chroma subsampling ratios based on an expected response of the human visual system. However, the adaptive chroma subsampling ratios may be varied based on the visual system of a particular user or group of users by a calibration process. During calibration, a user's color perception and vision may be used to fine tune an adaptive chroma subsampling scheme. The user's vision limits are determined and then applied to the adaptive chroma subsampling scheme.

In some cases, the adaptive change in chroma subsampling is delayed in a manner similar to how the human visual system is delayed in response to a change in brightness. For example, a change in the subsampling ratio may occur gradually, during a couple seconds as the human visual system adjusts to the change in brightness. Moreover, the subsampling ratios to be used herein are not restricted to typical ratios, such as 4:2:2, 4:2:1, 4:1:1, and the like. Rather, based on the ambient brightness, display brightness, and expected response of the human visual system, the subsampling may include ratios such as 4:3:2, 4:3:1, 4:1:3, 4:2:3, and the like. Although particular ratios are described here, the adaptive chroma subsampling may occur using any sampling ratio based on the ambient brightness, display/screen brightness, and expected response of the human visual system. As a result, the present techniques are distinguished from current display solutions that are independent of the brightness of the display screen.

FIG. 2 is a graph 200 illustrating vision types as compared to human photoreceptor cells. The vision types are compared to several lighting scenarios as measured by luminance 202. The lighting scenarios include no moon (overcast) 204, moonlight (full moon) 206, early twilight 208, store or office 210, and outdoors (sunny) 212. As discussed above, no bright line luminescence values exist that separate photopic vision 218 and scotopic vision 214. Instead, mesopic vision 216 is used to describe a band of transition between photopic vision 218 and scotopic vision 214. As illustrated, rod cells 220 are primarily responsible for scotopic vision 214, while cone cells 222 are primarily responsible for photopic vision 218. Mesopic vision is accomplished via a combination of rod cells 220 and cone cells 222. The graph 200 is illustrated with well-defined rod cell mediated vision 220 and cone cell mediated vision 222. However, in some cases neither the rod cells nor cone cells are completely “off.” Rather, the role of rod cells 220 and cone cells 222 can be greatly reduced during lighting scenarios where the respective photoreceptor cell has a reduced effectiveness. Accordingly, cones and rods may be used along a sliding scale in an adaptive fashion based on lighting conditions. As illustrated in the graph 200, mesopic vision may lie between 0.001 and 100 cd/m2. With respect to display brightness, the illumination range for mesopic vision is significantly covered in the illumination ranges for typical display devices.

For 4:4:4 YUV systems it becomes evident that there will be no benefit of 4:4:4 sampling during display brightness levels that fall in the range of mesopic vision due to the rod cells regime being more prominent. As the brightness decreases, the chroma sub-sampling may be decreased to send less color information as the human eye would be more sensitive to structure and less sensitive to color as the brightness level decreases. The present techniques propose using lower chroma subsampling when the brightness of the display falls in the range of mesopic vision. This will result in significant bandwidth saving (up to 50% between 4:4:4 and 4:2:0) for wireless displays as well as lower bus data transfer in wired displays resulting in lower power requirements during these scenarios.

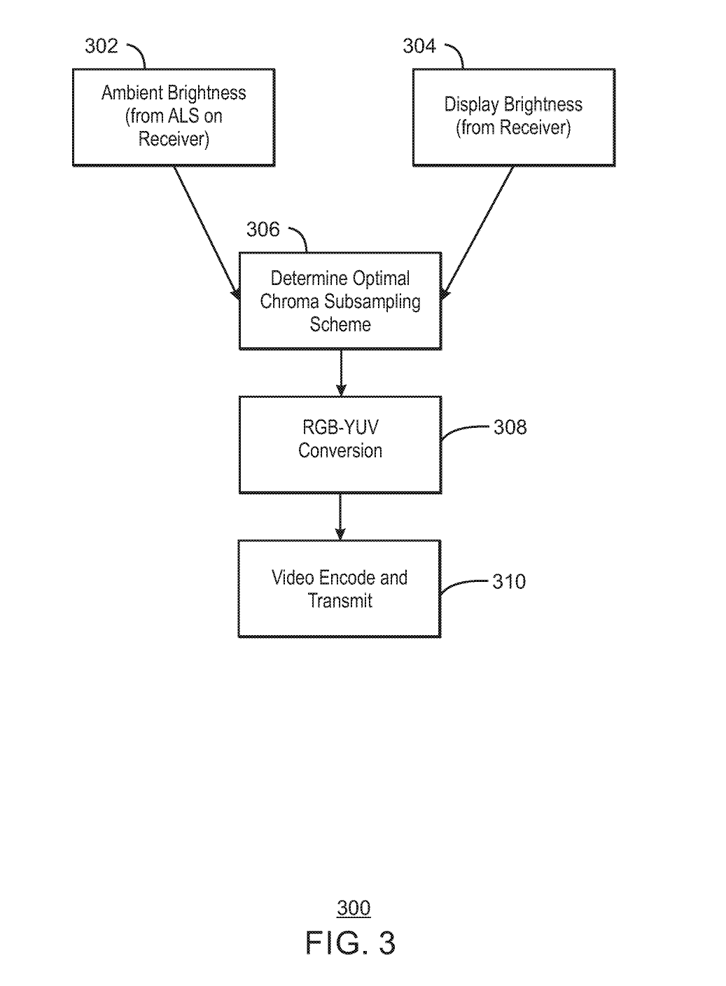

FIG. 3 is a block diagram of a wireless display transmitter 300. The wireless display transmitter 300 obtains a measure of the ambient brightness 302 and display brightness 304. The ambient brightness may be obtained from a brightness capture mechanism, such as an ambient light sensor (ALS) on the receiver. In embodiments, the receiver may be a wireless set top box, a cable box, a mobile device, a computing device, a tablet, a gaming console, and the like.

An optimum chroma subsampling scheme 306 is determined from these inputs, which is used to create the encoded video stream for transmission. In embodiments, an RGB-YUV conversion 308 is performed to convert the video stream to a YUV data space and perform chroma subsampling according to the determined chroma subsampling scheme. In embodiments, RGB input data may be chroma subsampled by implementing less resolution for the chroma information than for luma information. This subsampling may be performed via a YUV family of color spaces, where the Y component determines the brightness of the color, referred to as luminance or luma. The U and V components determine the color itself, which is the chroma. For example, U may represent the blue-difference chroma component, and V may represent the red-difference chroma component. In embodiments, the chroma subsampling is a YUV4:2:0 subsampling ratio. The YUV family of color spaces describes how RGB information is encoded and decoded, and the sampling ratio describes how the data will be decoded by implementing less resolution for chroma information than for luma information, taking advantage of the human visual system's lower acuity for color differences than for luminance based on the display brightness. The video may then be encoded and transmitted 310. In some cases, the ALS input 302 may not be used when the display used to render the video includes an ALS input to adjust their screen brightness. In such an example, the display brightness can be obtained from the display, which will also include ambient brightness values.

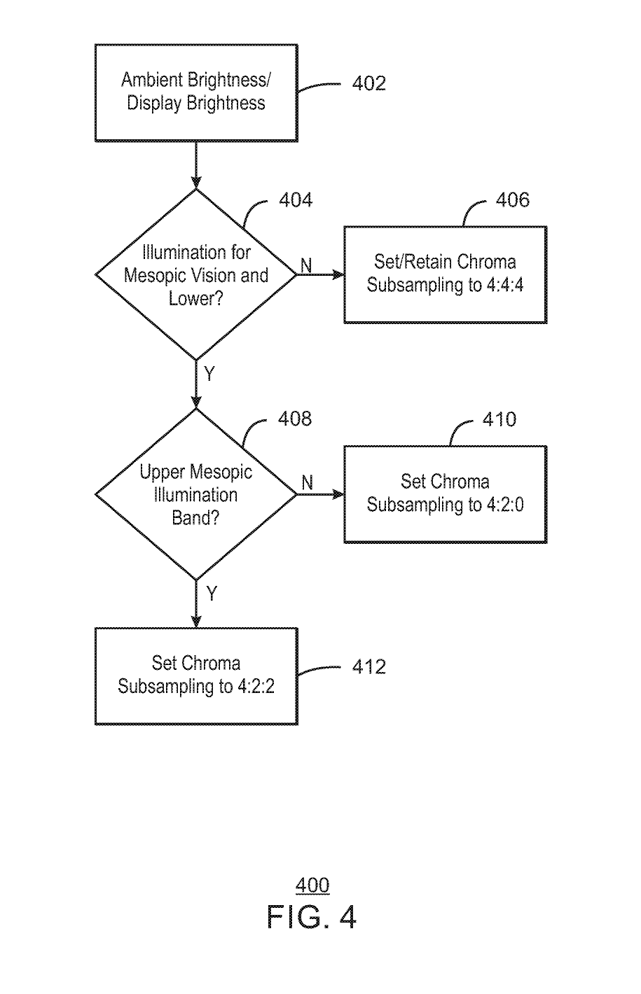

Once the brightness levels are analyzed, the chroma subsampling scheme may be selected as illustrated in FIG. 4. The chroma sampling in this example is limited to the common formats. However, finer changes in chroma subsampling driven by smaller changes in brightness may also be conceived to form intermediate levels of change of subsampling with display brightness. In some cases, the chroma subsampling ratio values may be stored in a look-up table or a mapping.

FIG. 4 is an illustration of determining a chroma subsampling scheme. At block 402, the ambient brightness and/or display brightness are used to determine if the illumination type falls into a range for mesopic vision and lower. If the illumination type does not fall into a range for mesopic vision or lower, process flow continues to block 406. At block 406, the chroma subsampling ration is set or retained at 4:4:4. As noted above, for 4:4:4 YUV systems it becomes evident that there will be no benefit of 4:4:4 sampling during display brightness levels that fall in the range of mesopic vision due to the rod cells regime being more prominent.

If the illumination type does fall into a range for mesopic vision or lower, process flow continues to block 408. At block 408, it is determined if the illumination type is in an upper mesopic illumination band. If the illumination type is not in an upper mesopic illumination band, process flow continues to block 410. At block 410, the chroma subsampling is set to 4:2:0. If the illumination type is in an upper mesopic illumination band, process flow continues to block 412. At block 412, the chroma subsampling is set to 4:2:2. In this manner, as the brightness decreases the chroma sub-sampling may be decreased to send less color information as the human eye would be more sensitive to structure and less sensitive to color as the brightness level decreases. The chroma subsampling ratios described herein are exemplary only. The chroma subsampling ratios according to the present techniques can be used for finer changes in chroma subsampling driven by smaller changes in brightness may also be conceived to form intermediate levels of change of subsampling with display brightness.

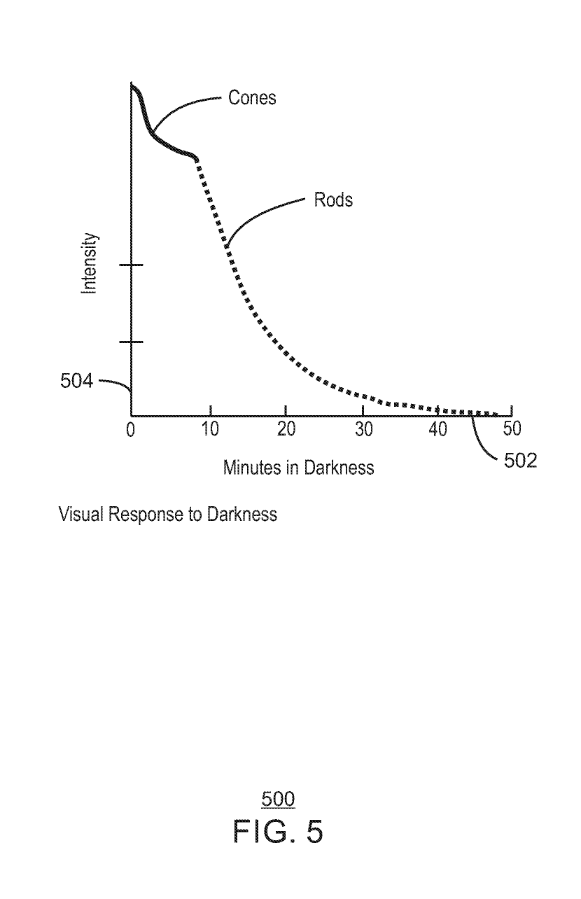

FIG. 5 is an illustration of the human visual response to darkness 500. The x-axis 502 represents the number of minutes in darkness, while the y-axis 504 illustrates the intensity of light. Since the visual response time of the human eye to darkness is of the order of minutes, the subsampling change may be applied after analysis of the ambient and display brightness over this period of time. For example, if the intensity drops from luminance of approximately 100 cd/m2 to luminance of approximately 0.01 cd/m2, the adaptive chroma subsampling ratio may be adjusted over a ten minute time frame.

By using an adaptive chroma subsampling scheme that is directly based on the human visual system response to changes in brightness, the size of the encoded data stream may be reduced since less information is stored for color information determined to be imperceptible to humans based on the lighting conditions. Further, power consumption is reduced when a smaller data stream is encoded, transmitted, received, decoded, and rendered.

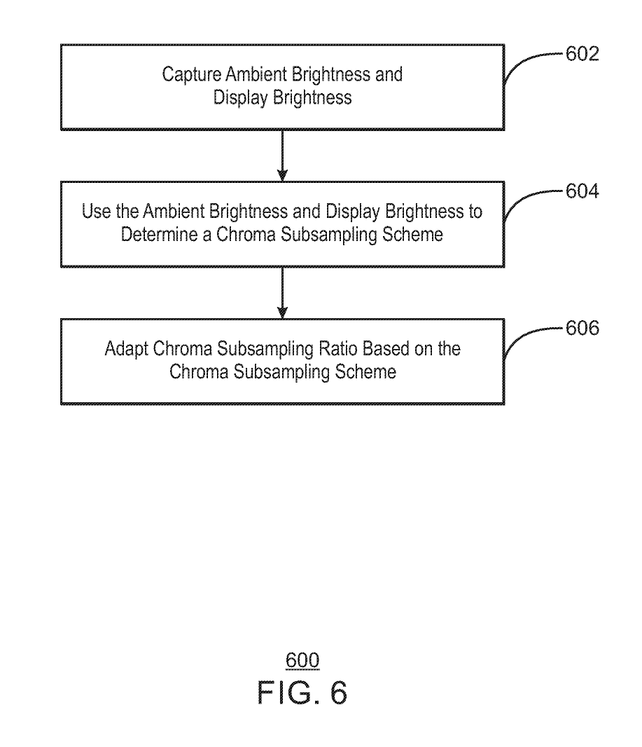

FIG. 6 is a process flow diagram of a method 600 for remote adaptation of streaming data based on the luminance at a receiver. At block 602, the ambient brightness and display brightness is captured. In embodiments, the ambient brightness and display brightness is captured on a periodic basis at an electronic device or a mobile device/mobile receiver. The ambient brightness and display brightness may include the luminance at the location the streaming video is to be rendered. Additionally, in embodiments, the ambient brightness and display brightness may be captured using a plurality of sensors, such as a camera sensor, RGB sensor, or an ALS sensor.

At block 604, the ambient brightness and display brightness are used to determine the chroma subsampling scheme. In embodiments, the ambient brightness and display brightness are used to determine the chroma subsampling scheme on a periodic basis. At block 606, the chroma subsampling is adapted based on the ambient brightness and display brightness. In particular, upon reception of luminance information captured at device level, or upon reception of environment information captured at device level that shows significant change when compared to a previously received and stored data, chroma subsampling may be adapted. Since the data encoding has been adapted for the ambient brightness and the display brightness, a power savings at the mobile device can occur since there is not unnecessary processing performed at the mobile device. Moreover, adaptation can be done either on-the-fly, or based on a look-up table.

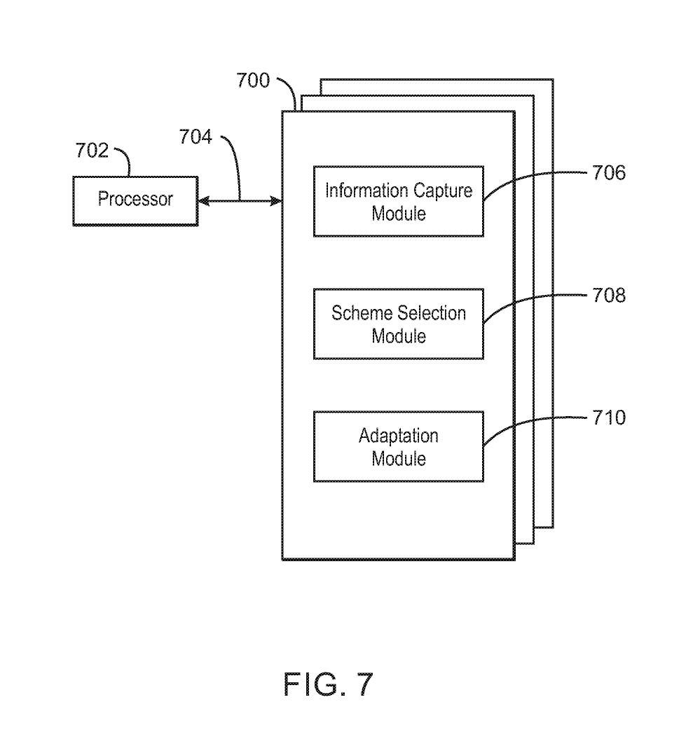

FIG. 7 is a block diagram showing media 700 that contains logic for adapting chroma subsampling based on display brightness. The media 700 may be a computer-readable medium, including a non-transitory medium that stores code that can be accessed by a processor 702 over a computer bus 704. For example, the computer-readable media 700 can be volatile or non-volatile data storage device. The media 700 can also be a logic unit, such as an Application Specific Integrated Circuit (ASIC), a Field Programmable Gate Array (FPGA), or an arrangement of logic gates implemented in one or more integrated circuits, for example.

The media 700 may include modules 706-710 configured to perform the techniques described herein. For example, an information capture module 706 may be configured to capture ambient brightness and display brightness at an electronic device. A scheme selection module 708 may be configured to select a chroma subsampling scheme based on the ambient brightness and display brightness. An adaptation module 710 may be configured to adapt the chroma subsampling ratio based on the chroma subsampling scheme. In some embodiments, the modules 706-710 may be modules of computer code configured to direct the operations of the processor 702.

The block diagram of FIG. 7 is not intended to indicate that the media 700 is to include all of the components shown in FIG. 7. Further, the media 700 may include any number of additional components not shown in FIG. 7, depending on the details of the specific implementation.

Example 1 is an apparatus. The apparatus includes a brightness capture mechanism to obtain ambient brightness and display brightness; a controller to determine a chroma subsampling scheme of media content based on the ambient brightness and display brightness according to a human visual system response, wherein the controller is to adapt a chroma subsampling ratio based on the ambient brightness and display brightness.

Example 2 includes the apparatus of example 1, including or excluding optional features. In this example, a bandwidth of the media content for wireless transmission is reduced according to the subsampling ratio. Optionally, reducing the volume of a bandwidth of the media content for wireless transmission is a result of transmitting only a chromatic content that can be perceived by humans.

Example 3 includes the apparatus of any one of examples 1 to 2, including or excluding optional features. In this example, the ambient brightness is brightness from lighting in a space that results from light sources in the space other than a display device.

Example 4 includes the apparatus of any one of examples 1 to 3, including or excluding optional features. In this example, the display brightness is brightness from lighting in a space that results from a display device.

Example 5 includes the apparatus of any one of examples 1 to 4, including or excluding optional features. In this example, the brightness capture mechanism is a plurality of sensors.

Example 6 includes the apparatus of any one of examples 1 to 5, including or excluding optional features. In this example, the brightness capture mechanism is a camera, an RGB sensor, an ambient light senor, or any combination thereof.

Example 7 includes the apparatus of any one of examples 1 to 6, including or excluding optional features. In this example, adapting the chroma subsampling ratio comprises a delay based on a delay in a vision change of the human visual system.

Example 8 includes the apparatus of any one of examples 1 to 7, including or excluding optional features. In this example, adapting the chroma subsampling ratio comprises a delay that is reflective of the best or reasonably good perceptual response to brightness change for humans.

Example 9 includes the apparatus of any one of examples 1 to 8, including or excluding optional features. In this example, adapting the chroma subsampling ratio comprises changing the chroma subsampling ratio instantly in response to a change in ambient brightness and display brightness.

Example 10 includes the apparatus of any one of examples 1 to 9, including or excluding optional features. In this example, the adapted chroma subsampling ratio is determined at a receiver and transmitted to a display where the media content is to be decoded.

Example 11 includes the apparatus of any one of examples 1 to 10, including or excluding optional features. In this example, the apparatus is a wireless set top box, a cable box, a mobile device, a computing device, a tablet, a gaming console, or any combination thereof.

Example 12 is a method. The method includes obtaining ambient brightness and display brightness from a receiver; determining a chroma subsampling scheme based on the ambient brightness and display brightness; and modifying a chroma subsampling ratio based on the chroma subsampling scheme.

Example 13 includes the method of example 12, including or excluding optional features. In this example, the method includes transmitting the chroma subsampling ratio to be used to decode a media content encoded using the chroma subsampling ratio.

Example 14 includes the method of any one of examples 12 to 13, including or excluding optional features. In this example, a bandwidth used to transmit a video is reduced according to the subsampling ratio. Optionally, a display used to render the video comprises an ambient light sensor, and the chroma subsampling scheme is solely based on the display brightness.

Example 15 includes the method of any one of examples 12 to 14, including or excluding optional features. In this example, the ambient brightness and the display brightness is captured using a plurality of sensors.

Example 16 includes the method of any one of examples 12 to 15, including or excluding optional features. In this example, the ambient brightness and the display brightness is captured using a camera, an RGB sensor, an ambient light senor, or any combination thereof.

Example 17 includes the method of any one of examples 12 to 16, including or excluding optional features. In this example, the method includes transmitting a video with a modified chroma subsampling ratio using wireless display (WiDi).

Example 18 includes the method of any one of examples 12 to 17, including or excluding optional features. In this example, the modified chroma subsampling ratio results in rendering only a chromatic content that can be perceived by humans.

Example 19 includes the method of any one of examples 12 to 18, including or excluding optional features. In this example, modifying the chroma subsampling ratio comprises a delay based on a delay in a vision change of the human visual system.

Example 20 includes the method of any one of examples 12 to 19, including or excluding optional features. In this example, modifying the chroma subsampling ratio comprises changing the chroma subsampling ratio instantly in response to a change in ambient brightness and display brightness.

Example 21 is a system. The system includes a display; a radio; a memory that is to store instructions and that is communicatively coupled to the display; and a processor communicatively coupled to the radio and the memory, wherein when the processor is to execute the instructions, the processor is to: receive a chroma subsampling scheme based on an ambient brightness and a display brightness; receive a media content encoded based on the chroma subsampling scheme; and decode the media content using a chroma subsampling ratio based on the chroma subsampling scheme.

Example 22 includes the system of example 21, including or excluding optional features. In this example, a bandwidth of the media for wireless transmission is reduced according to the subsampling ratio. Optionally, reducing the volume of a bandwidth of the media content for wireless transmission is a result of transmitting only a chromatic content that can be perceived by humans.

Example 23 includes the system of any one of examples 21 to 22, including or excluding optional features. In this example, the ambient brightness is brightness from lighting in a space that results from light sources in the space other than the display device.

Example 24 includes the system of any one of examples 21 to 23, including or excluding optional features. In this example, the display brightness is brightness from lighting in a space that results from a display device.

Example 25 includes the system of any one of examples 21 to 24, including or excluding optional features. In this example, the ambient brightness and the display brightness is obtained via a plurality of sensors.

Example 26 includes the system of any one of examples 21 to 25, including or excluding optional features. In this example, the ambient brightness and the display brightness is obtained via a camera, an RGB sensor, an ambient light senor, or any combination thereof.

Example 27 includes the system of any one of examples 21 to 26, including or excluding optional features. In this example, the system includes adapting the chroma subsampling ratio using a delay based on a delay in a vision change of the human visual system.

Example 28 includes the system of any one of examples 21 to 27, including or excluding optional features. In this example, the system includes adapting the chroma subsampling ratio by changing the chroma subsampling ratio instantly in response to a change in ambient brightness and display brightness.

Example 29 includes the system of any one of examples 21 to 28, including or excluding optional features. In this example, the chroma subsampling ratio is determined at a receiver and transmitted to a display where the media content is to be decoded.

Example 30 is at least one machine readable medium comprising a plurality of instructions that. The computer-readable medium includes instructions that direct the processor to obtain ambient brightness and display brightness from a receiver; determine a chroma subsampling scheme based on the ambient brightness and display brightness; and modify a chroma subsampling ratio based on the chroma subsampling scheme.

Example 31 includes the computer-readable medium of example 30, including or excluding optional features. In this example, the computer-readable medium includes transmitting the chroma subsampling ratio to be used to decode a media content encoded using the chroma subsampling ratio.

Example 32 includes the computer-readable medium of any one of examples 30 to 31, including or excluding optional features. In this example, a bandwidth used to transmit a video is reduced according to the subsampling ratio. Optionally, a display used to render the video comprises an ambient light sensor, and the chroma subsampling scheme is solely based on the display brightness.

Example 33 includes the computer-readable medium of any one of examples 30 to 32, including or excluding optional features. In this example, the ambient brightness and the display brightness is captured using a plurality of sensors.

Example 34 includes the computer-readable medium of any one of examples 30 to 33, including or excluding optional features. In this example, the ambient brightness and the display brightness is captured using a camera, an RGB sensor, an ambient light senor, or any combination thereof.

Example 35 includes the computer-readable medium of any one of examples 30 to 34, including or excluding optional features. In this example, the computer-readable medium includes transmitting a video with a modified chroma subsampling ratio using wireless display (WiDi).

Example 36 includes the computer-readable medium of any one of examples 30 to 35, including or excluding optional features. In this example, the modified chroma subsampling ratio results in rendering only a chromatic content that can be perceived by humans.

Example 37 includes the computer-readable medium of any one of examples 30 to 36, including or excluding optional features. In this example, modifying the chroma subsampling ratio comprises a delay based on a delay in a vision change of the human visual system.

Example 38 includes the computer-readable medium of any one of examples 30 to 37, including or excluding optional features. In this example, modifying the chroma subsampling ratio comprises changing the chroma subsampling ratio instantly in response to a change in ambient brightness and display brightness.

Example 39 is an apparatus. The apparatus includes instructions that direct the processor to a brightness capture mechanism to obtain ambient brightness and display brightness; a means to adapt chroma subsampling to determine a chroma subsampling scheme of media content based on the ambient brightness and display brightness according to a human visual system response, wherein the means to adapt chroma subsampling is to adapt a chroma subsampling ratio based on the ambient brightness and display brightness.

Example 40 includes the apparatus of example 39, including or excluding optional features. In this example, a bandwidth of the media content for wireless transmission is reduced according to the subsampling ratio. Optionally, reducing the volume of a bandwidth of the media content for wireless transmission is a result of transmitting only a chromatic content that can be perceived by humans.

Example 41 includes the apparatus of any one of examples 39 to 40, including or excluding optional features. In this example, the ambient brightness is brightness from lighting in a space that results from light sources in the space other than a display device.

Example 42 includes the apparatus of any one of examples 39 to 41, including or excluding optional features. In this example, the display brightness is brightness from lighting in a space that results from a display device.

Example 43 includes the apparatus of any one of examples 39 to 42, including or excluding optional features. In this example, the brightness capture mechanism is a plurality of sensors.

Example 44 includes the apparatus of any one of examples 39 to 43, including or excluding optional features. In this example, the brightness capture mechanism is a camera, an RGB sensor, an ambient light senor, or any combination thereof.

Example 45 includes the apparatus of any one of examples 39 to 44, including or excluding optional features. In this example, adapting the chroma subsampling ratio comprises a delay based on a delay in a vision change of the human visual system.

Example 46 includes the apparatus of any one of examples 39 to 45, including or excluding optional features. In this example, adapting the chroma subsampling ratio comprises changing the chroma subsampling ratio instantly in response to a change in ambient brightness and display brightness.

Example 47 includes the apparatus of any one of examples 39 to 46, including or excluding optional features. In this example, the adapted chroma subsampling ratio is determined at a receiver and transmitted to a display where the media content is to be decoded.

Example 48 includes the apparatus of any one of examples 39 to 47, including or excluding optional features. In this example, the apparatus is a wireless set top box, a cable box, a mobile device, a computing device, a tablet, a gaming console, or any combination thereof.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

1. An apparatus, comprising:
a brightness capture mechanism to obtain ambient brightness and display brightness;
a controller to determine a chroma subsampling scheme of media content based on the ambient brightness and display brightness according to a human visual system response, wherein the controller is to adapt a chroma subsampling ratio based on the ambient brightness and display brightness.

2. The apparatus of claim 1, wherein a bandwidth of the media content for wireless transmission is reduced according to the subsampling ratio.

3. The apparatus of claim 1, wherein the ambient brightness is brightness from lighting in a space that results from light sources in the space other than a display device.

4. The apparatus of claim 1, wherein the display brightness is brightness from lighting in a space that results from a display device.

5. The apparatus of claim 1, wherein the brightness capture mechanism is a plurality of sensors.

6. The apparatus of claim 1, wherein the brightness capture mechanism is a camera, an RGB sensor, an ambient light senor, or any combination thereof.

7. The apparatus of claim 1, wherein adapting the chroma subsampling ratio comprises a delay based on a delay in a vision change of the human visual system.

8. The apparatus of claim 1, wherein adapting the chroma subsampling ratio comprises a delay that is reflective of the best or reasonably good perceptual response to brightness change for humans.

9. The apparatus of claim 1, wherein adapting the chroma subsampling ratio comprises changing the chroma subsampling ratio instantly in response to a change in ambient brightness and display brightness.

10. The apparatus of claim 1, wherein the adapted chroma subsampling ratio is determined at a receiver and transmitted to a display where the media content is to be decoded.

11. The apparatus of claim 1, wherein the apparatus is a wireless set top box, a cable box, a mobile device, a computing device, a tablet, a gaming console, or any combination thereof.

12. A method, comprising:
obtaining ambient brightness and display brightness from a receiver;
determining a chroma subsampling scheme based on the ambient brightness and display brightness; and
modifying a chroma subsampling ratio based on the chroma subsampling scheme.

13. The method of claim 12, comprising transmitting the chroma subsampling ratio to be used to decode a media content encoded using the chroma subsampling ratio.

14. The method of claim 12, wherein a bandwidth used to transmit a video is reduced according to the subsampling ratio.

15. The method of claim 14, wherein a display used to render the video comprises an ambient light sensor, and the chroma subsampling scheme is solely based on the display brightness.

16. A system, comprising:
a display;
a radio;
a memory that is to store instructions and that is communicatively coupled to the display; and
a processor communicatively coupled to the radio and the memory, wherein when the processor is to execute the instructions, the processor is to:
receive a chroma subsampling scheme based on an ambient brightness and a display brightness;
receive a media content encoded based on the chroma subsampling scheme; and
decode the media content using a chroma subsampling ratio based on the chroma subsampling scheme.

17. The system of claim 16, wherein a bandwidth of the media content for wireless transmission is reduced according to the subsampling ratio.

18. The system of claim 16, wherein reducing a volume of a bandwidth of the media content for wireless transmission is a result of transmitting only a chromatic content that can be perceived by humans.

19. The system of claim 16, wherein the ambient brightness is brightness from lighting in a space that results from light sources in the space other than the display device.

20. The system of claim 16, wherein the display brightness is brightness from lighting in a space that results from a display device.

21. The system of claim 16, wherein the ambient brightness and the display brightness is obtained via a plurality of sensors.

22. The system of claim 16, wherein the ambient brightness and the display brightness is obtained via a camera, an RGB sensor, an ambient light senor, or any combination thereof.

23. At least one non-transitory machine readable medium comprising a plurality of instructions that, in response to being executed on a computing device, cause the computing device to:
obtain ambient brightness and display brightness from a receiver;
determine a chroma subsampling scheme based on the ambient brightness and display brightness; and
modify a chroma subsampling ratio based on the chroma subsampling scheme.

24. The computer readable medium of claim 23, comprising transmitting a video with a modified chroma subsampling ratio using wireless display (WiDi).

25. The computer readable medium of claim 23, wherein the modified chroma subsampling ratio results in rendering only a chromatic content that can be perceived by humans.
